(19) United States
(12) Patent Application Publication
(10) Pub. No.: US 2005/0270389 A1
(43) Pub. Date: Dec. 8, 2005

(54) Method and device using CCD-based low noise parametric amplifier

(75) Inventors: Ed Wuori, Mounds View, MN (US); Frank John Bohac JR., Tustin, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Transoma Medical, Inc., St. Paul, MN (US)

(21) Appl. No.: 11/140,537

(22) Filed: May 26, 2005

Related U.S. Application Data
(60) Provisional application No. 60/575,528, filed on May 28, 2004.

(51) Int. Cl. H04N 5/335

(52) U.S. Cl. 348/294

(57) ABSTRACT

Embodiments of the present invention provide a device with an integrated low-noise parametric amplifier using a CCD-based structure with minimal noise gain. In one embodiment, a device which may be used for monitoring and/or diagnosing a human or an animal body comprises a CCD-based device including a first gate forming a first capacitor and a second gate forming a second capacitor, the first capacitor having a surface area larger than a surface area of the second capacitor; and a controller configured to input a signal to the CCD-based device; convert the input signal into a charge packet having a voltage associated therewith; transfer the charge packet from the first capacitor to the second capacitor of the CCD-based device, the voltage associated with the charge packet being multiplied by a ratio of the surface area of the first capacitor divided by the surface area of the second capacitor; and produce an amplified output signal from the multiplied voltage.

### CROSS-REFERENCES TO RELATED APPLICATIONS

This application claims the benefit of U.S. Provisional Patent Application No. 60/575,528, filed May 28, 2004, the entire disclosure of which is incorporated herein by reference.

### BACKGROUND OF THE INVENTION

Charge-coupled devices (CCDs) are well known for their use as sensors in digital imaging and video processing. Specifically, they consist of an array of linked or coupled capacitors, where sampled values of an analog signal are stored as charge. The charge can be shifted along the capacitor array by an applied or clock voltage, thus propagating the charge through the array. The charge is eventually transferred from the CCD as an output signal. Amplification of the output signal is usually required, however, because the signal may be too weak to be accurately read or used in a later stage, or because subsequent operations require a certain threshold voltage. An off-chip amplifier is conventionally used for this process, connected in sequence with the output of the CCD.

Conventional amplifiers achieve low noise by using large input transistor structures to average noise sources. One of the primary difficulties with using conventional amplification techniques is that signal gains made as a result of amplification can also result in an increase in the amount of noise present. This can cause problems in signal clarity, distortion of the output signal in relation to the input signal, or degeneration of the signal through unintentional negative feedback. For this reason, noiseless amplification of signals is desired, particularly in a CCD-based structure.

Within a paper entitled, “Discrete-Time Parametric Amplification Based on a Three-Terminal MOS Varactor: Analysis and Experimental Results” by S. Ranganathan and Y. Tsividis, a parametric technique of increasing voltage gain in an MOS varactor was disclosed. This technique utilizes discrete-time parametric amplification to receive an input voltage that is held on a capacitor, as shown in FIG. 7A-7C. After an input voltage is provided as indicated in FIG. 7A, the capacitor in FIG. 7B is isolated by opening a switch to the voltage source, thus holding the voltage on the capacitor C_{I} to a value V_{I}. Correspondingly, the charge on the capacitor can be determined by the equation Q=C_{I}V_{I}. By increasing the space between the capacitor plates as illustrated in FIG. 7C, the capacitance is now reduced to a value C_{O}, and the voltage across the capacitor is thus V_{O}=Q/C_{O}. As the charge has remained the same, the voltage V_{O} now equals:
V_{O}=(C₁/C_{O})*V_{I}.
Thus, the voltage across the capacitor corresponds to a ratio between the initial capacitance value C_{I} and the output capacitance value C_{O}. The technique of amplification described above does involve a noise factor kT/C associated with the sampling process, although the amplification process is essentially noiseless as it is performed after sampling the signal.

### BRIEF SUMMARY OF THE INVENTION

Embodiments of the present invention provide a device with an integrated low-noise parametric amplifier using a CCD-based structure with minimal noise gain. The CCD-based structure may be integrated into an IC chip for a medical monitoring and/or diagnostic device. The amplification of the signal is achieved by using a method of capacitance modulation by varying the surface area of the capacitor plates which are used to convey the charge rather than conventional amplification techniques utilizing transistor transconductance. The corresponding voltage gain introduces very little noise, because no additional sources of noise such as active components are introduced in the charge amplification process while shifting the charge from the larger CCD gate to the smaller CCD gate. The CCD capacitance ratio approach is essentially forming a varactor with a very large turn-down ratio.

A discrete sample of an analog input signal is first taken by the CCD-based structure and converted into a charge, for instance, using a well known method such as a “fill-and-spill” technique. The charge is stored below the surface as minority carriers. By applying a clock voltage to the gates in the device, potential wells are created and shifted accordingly to the voltage input to the gates. The charge present within the potential wells is also transferred as the clock voltage is cycled. The charge can also be referred to as a charge packet as it is a small amount of charge held underneath the gate when a voltage is applied. By moving the charge packet from a gate with a larger surface area to one with a smaller surface area, a voltage gain can be produced because the amount of charge remains the same while the effective capacitance is reduced. The charge can then be outputted from the CCD using either a floating diffusion region or floating gate connected to a sense transistor.

Advantageously, a CCD-based amplifier using the present approach can be implemented in a smaller area than a comparable CMOS process. The gain obtained by the method of this invention can greatly relax noise requirements for any later amplification by transistors, and thus the area occupied by the transistor can also be reduced significantly. This aids in the integration of the CCD-based structure into a larger silicon device incorporating several functions.

One specific application of the current invention is for use in amplifying signals taken from electrocardiogram (ECG) electrodes. One electrode is commonly used as a reference voltage, and the other electrode is used as a signal voltage. Both electrodes are attached to a patient's body, and their respective ends are connected to gates in the CCD which control the input of charge into the CCD. A charge packet equal to the difference in voltages can be created and amplified by the method as described in this invention. Alternatively, a single electrode can be used as the input to create a charge packet of a size equivalent to the voltage input from the electrode and then amplified. The difference between electrode inputs can be calculated at a later point after output from the CCD. Because the electrode connections preferably are directly inputted into the CCD, this results in a high impedance value. This is desirable to avoid any adverse reaction from the patient as a result of the electrical connection to the CCD.

In accordance with an aspect of the present invention, a method of amplifying a signal comprises inputting a signal to a CCD-based device which includes a first gate forming a first capacitor and a second gate forming a second capacitor, the first capacitor having a surface area larger than a surface area of the second capacitor; converting the input signal into a charge packet having a voltage associated therewith; transferring the charge packet from the first capacitor to the second capacitor of the CCD-based device, the voltage associated with the charge packet being multiplied by a ratio of the surface area of the first capacitor divided by the surface area of the second capacitor; and producing an amplified output signal from the multiplied voltage.

In some embodiments, inputting the signal comprises connecting an end of a first electrode to a human or animal body and another end of the first electrode to the CCD-based device. Inputting the signal comprises supplying charges from the first electrode to a diffusion region of the CCD-based device; and converting the signal into a charge packet comprises converting the charges from the first electrode in the diffusion region to the charge packet for the first capacitor, the charge packet being proportional to a voltage associated with the first electrode.

In specific embodiments, inputting the signal comprises connecting an end of a second electrode to a human or animal body and another end of the second electrode to the CCD-based device. Inputting the signal comprises connecting the end of the first electrode to the first gate and connecting the end of the second electrode to a third gate of the CCD-based device, the first electrode having a first voltage associated therewith and the second electrode having a second voltage associated therewith; and converting the signal into a charge packet comprises applying a voltage to a diffusion region of the CCD-based device to generate the charge packet for the first capacitor which is proportional to a difference between the first voltage and the second voltage.

In some embodiments, the method further comprises sampling the signal to create a discrete sample of the input signal prior to converting the discrete sample of the input signal into a charge packet. The charge packet is transferred from the first capacitor to the second capacitor in a substantially noiseless manner. The input signal is used to generate a plurality of charge packets in a plurality of input cycles; and the plurality of charge packets are transferred to and stored in the second capacitor to generate the multiplied voltage before producing the amplified output signal from the multiplied voltage. Producing the amplified output signal comprises transferring the charge packet to a floating diffusion region or a floating gate of the CCD-based device.

In accordance with another aspect of the invention, a method of amplifying a signal comprises inputting a signal to a CCD-based device which includes a plurality of gates forming a plurality of capacitors; converting the input signal into a charge packet having a voltage associated therewith; transferring the charge packet during an input cycle to a storage capacitor associated with one of the plurality of gates; storing multiple charge packets in the storage capacitor over a plurality of input cycles by not resetting the storage capacitor during each of the plurality of input cycles, an accumulated voltage associated with the charge packets being equal to a sum of the voltages associates with each of the multiple charge packets stored in the storage capacitor; and producing an amplified output signal from the accumulated voltage.

In some embodiments, inputting the signal comprises connecting an end of at least one electrode to a human or animal body and another end of the at least one electrode to the CCD-based device. The method may further comprise sampling the signal to create a discrete sample of the input signal prior to converting the discrete sample of the input signal into a charge packet. The charge packets are transferred to the storage capacitor in a substantially noiseless manner. A programmable voltage gain is obtained from the accumulated voltage by varying the number of charge packets accumulated in the storage capacitor before resetting the storage capacitor.

In accordance with another aspect of this invention, a device comprises a CCD-based device including a first gate forming a first capacitor and a second gate forming a second capacitor, the first capacitor having a surface area larger than a surface area of the second capacitor; and a controller configured to input a signal to the CCD-based device; convert the input signal into a charge packet having a voltage associated therewith; transfer the charge packet from the first capacitor to the second capacitor of the CCD-based device, the voltage associated with the charge packet being multiplied by a ratio of the surface area of the first capacitor divided by the surface area of the second capacitor; and produce an amplified output signal from the multiplied voltage. The CCD-based device may comprise a single polysilicon structure or a double polysilicon structure.

In accordance with another aspect of the present invention, a device comprises a CCD-based device including a plurality of gates forming a plurality of capacitors; and a controller configured to convert the input signal into a charge packet having a voltage associated therewith; transfer the charge packet during an input cycle to a storage capacitor associated with one of the plurality of gates; store multiple charge packets in the storage capacitor over a plurality of input cycles by not resetting the storage capacitor during each of the plurality of input cycles, an accumulated voltage associated with the charge packets being equal to a sum of the voltages associates with each of the multiple charge packets stored in the storage capacitor; and produce an amplified output signal from the accumulated voltage.

### BRIEF DESCRIPTION OF THE DRAWINGS

FIG. 1 shows a cross-section of an integrated CCD-based structure according to an embodiment of the present invention, where two electrodes are connected to the structure to allow a differential voltage to be trapped as a charge packet using a fill and spill method.

FIG. 2 shows a cross-section of an integrated CCD-based structure according to another embodiment of the present invention, where a single input electrode is connected to the structure to allow the input voltage to be trapped as a charge packet using a fill and spill method.

FIG. 3 is a cross-section of an integrated CCD-based structure according to an embodiment of the invention, where the trapped charge packet has been propagated within the CCD-based structure by controlling the gate voltages to lie below a gate with a large surface area.

FIG. 4 is a cross-section of an integrated CCD-based structure according to an embodiment of the invention, where the trapped charge has been propagated to lie directly below a gate with a smaller surface area, thus raising the voltage associated with the charge packet.

FIG. 5 is a cross-section of an integrated CCD-based structure according to an embodiment of the invention, in which the amplified charge packet moves to a floating diffusion region to be sensed for output.

FIG. 6 is a cross-section of an integrated CCD-based structure according to an embodiment of the invention, in which the amplified charge packet moves to a floating gate to be sensed for output.

FIG. 7A is a simplified circuit diagram showing a prior amplification method in parallel-plate capacitors, where a capacitor receiving an input voltage from a voltage source.

FIG. 7B is a simplified circuit diagram showing the prior amplification method in parallel-plate capacitors of FIG. 7A, where the capacitor is disconnected from the voltage source, and the input voltage is maintained across the capacitor.

FIG. 7C is a simplified circuit diagram showing the prior amplification method in parallel-plate capacitors of FIG. 7A, where the distance between the capacitor plates is increased, resulting in an increase in voltage.

FIG. 8A is a simplified schematic view of a CCD-based structure illustrating a double poly implementation according to an embodiment of the present invention.

FIG. 8B is a timing diagram associated with the CCD-based structure of FIG. 8A.

FIG. 9A is a simplified schematic view of a CCD-based structure illustrating a single poly implementation according to an embodiment of the present invention.

FIG. 9B is a timing diagram associated with the CCD-based structure of FIG. 9A.

FIG. 10 is a simplified schematic view of a medical device incorporating a CCD-based structure of according to an embodiment of the present invention.

### DETAILED DESCRIPTION OF THE INVENTION

FIG. 1 shows a cross-section of a CCD-based structure 10 according to an exemplary embodiment of the invention, where an interface exists for contact with the voltage inputs. In this embodiment, the voltage inputs are connected to ECG electrodes as part of a medical monitoring and/or diagnostic device that incorporates the CCD-based structure 10 or to some other comparable analog voltage-generating device. The CCD is formed on a p-silicon substrate 12 doped by an ion-implant process, and a layer of oxide 14 is grown on top of the silicon for use as a dielectric layer, where the channel formed is an n-channel. The device could alternatively be manufactured on an n-silicon substrate with a p-channel, with no additional complexity added to the process. An opening in the oxide layer is formed and an n+ region 18 is implanted and diffused into the silicon to form a diffusion region. Polysilicon gates are formed on top of the oxide region, and provide voltage inputs for creating and transferring the charge packet with an applied or clock voltage. Specifically, the first electrode associated with the voltage ECG1 is connected to the first gate 22, the second electrode associated with the voltage ECG2 is connected to the second gate 24, and a third connection with control voltage V0 is made to the third gate 26. One electrode is used to produce a reference voltage (e.g., ECG1), and the second electrode is used to produce a signal voltage (e.g., ECG2). The diffusion region 18 is connected to the input voltage VD. A minimum voltage value is constantly applied to the gates to maintain the inversion region below the oxide layer to allow charge transfer to progress. At least three gates are necessary to introduce directionality into the charge transfer process.

In addition to the CCD-based structure, FIG. 1 shows a graphical representation of the surface potential present in the structure, with the y-axis representing potential. In the diagram shown, potential decreases in an upward direction, and increases in a downward direction. The diode present at the junction between the n+ diffusion region 18 and the p+ substrate 12 is first reverse biased to a voltage level VD1 to prevent current flow. A given surface potential exists in the potential well associated with the diffusion region, as shown by the shaded area 30. The voltage ECG2 is greater than the voltage ECG1, as the potential well associated with ECG2 is deeper. Thus, in accordance with the “fill-and-spill” technique, the diode is briefly pulsed to a lower voltage VD1 (by raising its charge level so that the charge exceeds the potential boundary overfilling the well under ECG2) and then raised back to a higher voltage level VD2 (by lowering its charge level as seen in FIG. 1). When the voltage level of the diode is at VD1, the surface potential is temporarily associated with the value VD1 and raises up to fill the floating potential area under ECG2. When the voltage level returns to VD2, any excess surface potential flows out through the diode. The charge packet which is proportional to (ECG1-ECG2) remains, because it is constrained by the potential barriers existing on either side of the well due to the lower voltages being exerted by ECG1 and V0. Thus, an amount of charge equivalent to the difference in voltages between ECG1 and ECG2 has been obtained. The charge packet can then be moved on to gate 26 and on to other gates by applying a periodic gate voltage.

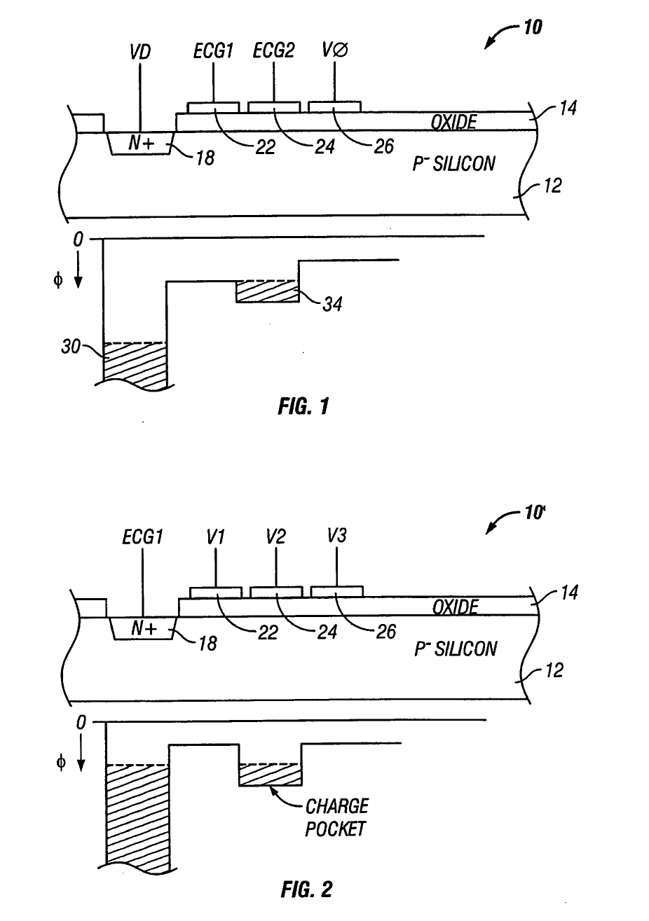

FIG. 2 shows another method of converting an input voltage to an equivalent charge amount. In the CCD-based structure 10′ of FIG. 2, ECG1 is now the input voltage to the diffusion region 18, while V1, V2, and V3 are the control voltages provided to the gates 22, 24, 26, respectively. Similar to the first method, the diode is reverse biased to a given voltage V1. In the “fill-and-spill” technique, when the diode is pulsed to a lower value V2, the surface potential amount rises in the potential well below ECG1 to spill over the potential barrier formed by the lower voltage V1 and into the potential well below V2. The amount of charge spilled over into the potential well V2 is equivalent to the increase in voltage seen in ECG1. When ECG1 is pulsed back to V1, any excess potential flows out through the diode, but the charge packet associated with ECG1 remains. Transfer of the charge packet can now occur by varying the series of gate voltages, beginning with V3. Alternatively, a second input area could also be employed to produce a charge packet proportional to ECG2 in parallel with the first input area, and the two packets corresponding to the voltage inputs could be compared to produce a differential output at a later step.

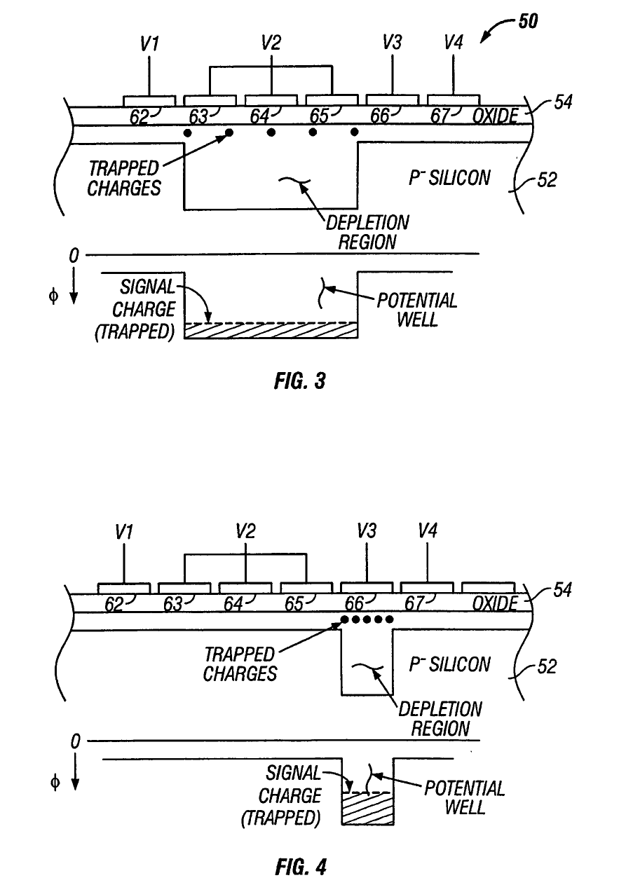

FIG. 3 shows an initial cross-section of the CCD-based structure 50 having a substrate 52 and an oxide layer 54, after the signal charge has already has already been injected into the CCD-based structure 50, for instance, using the method as shown in FIG. 1, or alternatively, as shown in FIG. 2. A plurality of gates 62-67 are formed on top of the oxide. The surface areas of the gates 62, 66, 67 associated with voltages V1, V3, and V4 are equal, but the surface area of the gate associated with V2 is roughly three times as large as the area of the other gates. The gate associated with V2 has been shown as three separate gates 63, 64, 65 tied to the same gate voltage V2 to accurately illustrate this concept. The trapped charge is shown here as being stored at the surface of the p-silicon region as minority carriers. A channel region is present below the oxide region as a pathway for the charge to move therein. The charge is kept in the silicon region below the gate associated with the gate voltage V2 because the level of voltage V2 applied is temporarily higher than those applied to the neighboring gates associated with V1 and V3, thus preventing the charge from moving. It is assumed that the polysilicon gates are spaced close together enough to avoid forming a potential barrier between gates with similar gate voltages.

Additionally, it is desirable that all gate voltages are of a sufficient magnitude to form a channel region below them. The voltage V2, however, is of a large enough magnitude to form a much deeper depletion region. In conventional operation, electrons are trapped at the silicon-SiO₂ interface. As long as these trap sites remain filled, they will not affect operation. However, if the channel is ever depleted of charge when the signal equals zero, the trap sites will over time recombine with electrons and leave empty traps. The first charge packets to progress down the depletion region will lose some of their electrons to re-fill the traps, and restore the potential level. To avoid this error, the depletion regions are typically clocked with some minimum level of charge greater than zero, commonly known as a “Fat Zero.” With the relatively small input amplitudes expected, it is important to keep some minimum charge moving through the channel to keep the traps filled.

A surface potential plot corresponding to the CCD cross-section is also shown in FIG. 3. A large potential well exists in the region corresponding to the voltage V2, and the potential contains an amount of trapped signal charge, for instance, as introduced by the “fill-and-spill” method as shown in FIGS. 1 and 2. The gates 63-65 under voltage V2 in FIG. 3 correspond to the gate 24 in FIG. 1 under ECG2 or the gate 24 in FIG. 2 under V2.

FIG. 4 shows the result of shifting the signal charge from under the capacitor or gate (63-65) associated with V2 to a smaller capacitor or gate 66 associated with V3 with approximately one-third the surface area. Directional movement of the charge is induced in the CCD by pulsing the gate voltage V3 to a higher level, and lowering the voltage V2. The higher voltage V3 asserted causes a depletion region to form beneath V3, and the depletion region is reduced under V2 due to the lower voltage asserted for V2. The surface potential diagram of FIG. 4 displays a corresponding potential well associated with asserted voltage V3.

When an input signal charge has been fixed and trapped on the capacitor formed by the voltage gates and the inversion region in the substrate, a voltage is produced. Because capacitance of a parallel-plate capacitor is proportional to the area of the plates, a decrease in the area of the capacitor can cause the capacitance value to be reduced while holding the same charge. As applied in the equation Q=CV, if the capacitance value decreases while the same charge is held, the voltage associated with the charge packet must increase. Thus, by moving the trapped charge packet from one gate element to another gate element that has a much smaller capacitance by design, the voltage associated with the charge packet is increased according to the capacitance ratio of the two gate elements.

In FIGS. 3 and 4, the signal charge packet is being shifted from a capacitor associated with V2 to a capacitor associated with V3, where the capacitor formed in FIG. 3 (gates 63, 64, 65) has a surface area of three times as large as that formed in FIG. 4 (gate 66). Because the surface area of the capacitors involved has been reduced by a factor of three, the voltage associated with the charge packet is accordingly increased by a factor of three.

While the current drawings show the surface area of V2 as compared to V3 and the corresponding voltage gain associated with the packet in a 3 to 1 ratio, it is to be understood that other surface areas could also be employed with similar results. For example, charge transfer from a gate with surface area two times as large as the second gate could also be employed, with a corresponding 2 to 1 gain in the voltage associate with the signal charge. Similarly, a charge transfer from a gate with a surface area 10 times as large as a second gate could be employed, with a 10 to 1 gain. The CCD-based structure or amplifier may be designed to provide any desired gain, although a practical limitation may exist in that any increase in the surface area of the gates being used also results in a similar increase in difficulty of integration and added complexity for manufacturing techniques.

Once the input voltage has been sampled and held, the method used for voltage gain does not involve resistors or active components and thus the amplification ideally is virtually noiseless. There are, however, contributors to noise present in a practical application. For a surface CCD implementation as described above, surface interface traps at the silicon-oxide interface can cause low frequency noise and carrier ballistics can cause high frequency noise. Nonetheless, the significant reduction in noise presents an important advantage over prior techniques.

One additional contributor to noise particularly relevant to this application is “Dark Current,” or the accumulation of charge in the potential wells between samples, as introduced by either thermal or photo generation mechanisms. This accumulation rate is at a minimum when there is little or no photocurrent. If the clock rate is slow, this current may be significant in creating charge buildup. To minimize the effect of dark current, the clocks can be run at a faster rate and the actual sample can be after several clock cycles, enough to flush the channel. The CCD-based structure can be cooled to a low temperature with liquid nitrogen or shielded from light to reduce this effect. Ideally, the dark current noise should be reduced to a point where its contribution is negligible over a typical exposure time.

The use of capacitance modulation to increase voltage in the CCD-based structure is similar to the use of a varactor with a very high turn-down ratio. A varactor is a specific kind of diode where voltage can be used to control a variable capacitance formed by the migration of electrons and holes in p-n junction. In the present embodiment, the gate voltage inputted is used to control the transfer of charge between gates of different surface areas, and thus capacitances.

Another method of achieving voltage gain is to input multiple charge packets into a storage capacitor (e.g., capacitor associated with V2 in FIGS. 3 and 4) in the CCD-based structure, without resetting the output capacitor (e.g., capacitor associated with V3 in FIGS. 3 and 4) between samples. If the output capacitor is not reset between cycles, then that capacitor will act as an integrator, effectively beginning a process of charge accumulation. The process of storing charge packets in the storage capacitor is similar to a “sample-and-hold” sequence. The incoming charge packets will accumulate in the potential wells associated with the capacitor, until a reset signal is given. If several charge packets are transferred in and the clock voltage is controlled to allow accumulation of the packets, then the amplitude of the input signal is effectively multiplied by the number of sample cycles, given that the input charge is kept small enough to not overflow the potential well. This has the advantage of allowing the gain to be controlled by the number of clock cycles instead of the CCD geometry. The gain obtained is thus inversely proportional to the frequency of the reset operation. An additional advantage of this method is that noise accumulated with the packet transfer may be reduced, in that averaging the noise values for the accumulated packets compensates for oversampling of signals. A programmable voltage gain is obtained from the accumulated voltage by varying the number of charge packets accumulated in the storage capacitor before resetting the storage capacitor.

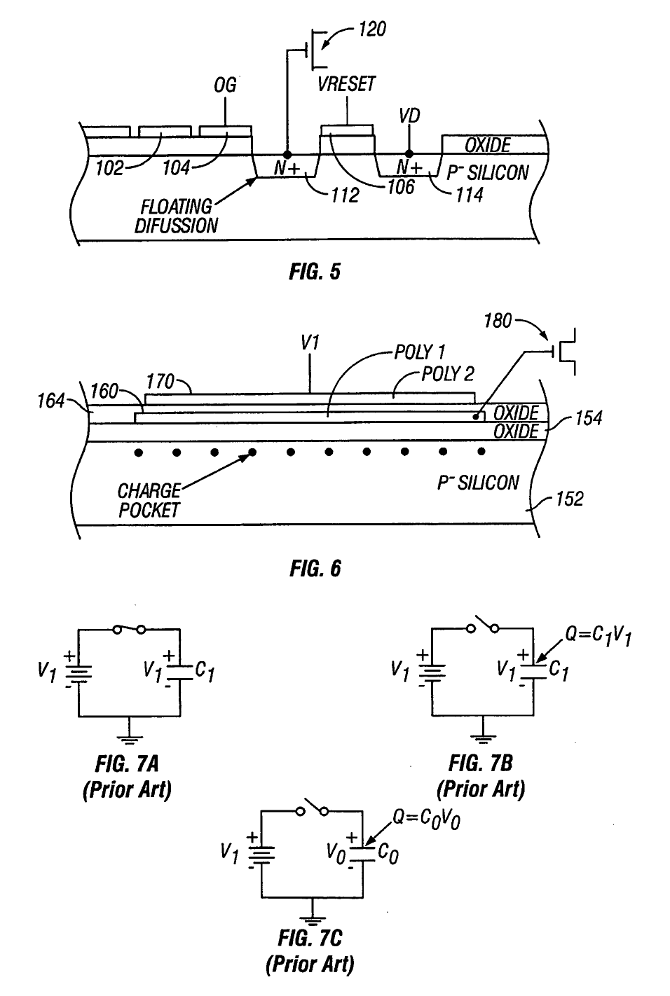

After the voltage associated with the signal charge has been amplified, the signal is outputted for further processing. Any suitable output method may be employed. Two methods for charge output are shown in FIGS. 5 and 6 that utilize a floating diffusion region and a floating gate, respectively, for output.

In FIG. 5, a destructive method of sensing the charge packet is utilized. The method described is characterized as destructive in that the signal charge is discarded after measurement. A final transfer gate 102, output gate 104, and reset gate 106 are present, along with two floating diffusion regions including a first floating diffusion region 112 tied to a sense transistor 120 and a drain 114 biased to the DC voltage VD. As a charge packet is transferred to the final transfer gate 102, it exists in a potential well below the gate. When a voltage is asserted to the output gate 104, the corresponding potential well lowers and the charge packet spills over to the potential well beneath the floating diffusion region 112. As the charge flows into the diode, the potential associated with the well is lowered. The potential drop experienced is equivalent to the amount of charge flowing through it. By connecting the gate of the sense transistor 120 to the floating diffusion region 112, a potential drop across the floating diffusion causes a corresponding change in the gate voltage of the MOSFET and a shift in the drain current. This shift in the drain current can be measured as an output value. As a short voltage pulse V_{RESET} is applied to the reset gate 106, the potential well associated with the reset gate 106 is lowered and the charge present near the floating source region 112 is then transferred to the drain 114. Additional details of this charge output method can be found, for example, in Dieter K. Schroeder, Advanced MOS Devices, Addison-Wesley Pub. (1987), the disclosure of which is incorporated herein by reference.

In FIG. 6, a non-destructive method of sensing the charge packet using a floating gate structure is utilized. In this structure, a first polysilicon layer 160 is formed over the oxide layer 154 directly above the p-silicon substrate 152. A second oxide layer 164 is then formed over the first polysilicon layer 160. Finally, a second polysilicon layer 170 is formed on the second oxide layer 164, and attached to voltage input V1. The first poly layer 160 is the floating gate, and is connected to a sense transistor 180. When a charge packet in the silicon region 152 is sensed, the potential associated with the floating gate 160 changes. If the gate of the device is floating and was initially precharged to a high potential, then the gate voltage will also be modified due to capacitive coupling between the semiconductor and the oxide. Thus, the charge packet input to the floating gate 160 can be converted to a voltage output. Additional details of this charge output method can be found, for instance, in G. S. Hobson, Charge-Transfer Devices, John Wiley & Sons, New York (1978), the disclosure of which is incorporated herein by reference.

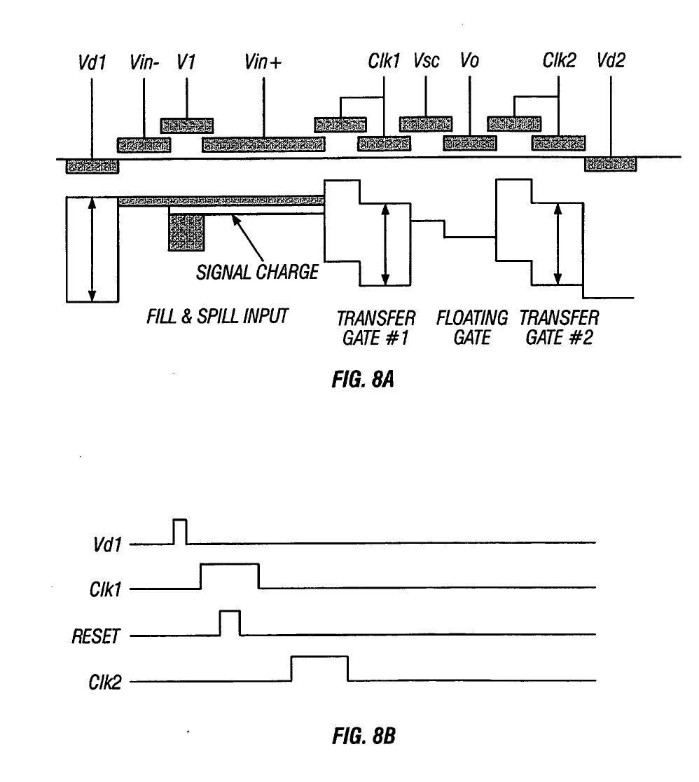

In FIG. 8A, a specific implementation of the CCD-based structure using a double polysilicon process is shown. CCDs are often formed with two polysilicon layers so that a combination of the 1^{st} and 2^{nd} polysilicon layers forms a single “bucket” with a built-in directionality. The left-most diffusion region and three gates (Vd1, Vin−, and V1) form the “fill-and-spill” input, as described above. The Vin+ gate length has been increased to provide a larger signal charge per input voltage, thus providing gain. The next two gates (first transfer gate associated with transfer clock Clk1) control the transfer of charge packets to the metering or “floating” gate, which must be reset to a known voltage before each transfer. The poly2 (or 2^{nd} layer) gate tied to Vsc screens the poly1 Vo gate from the transfer clock Clk1 and provides directionality. The area of the Vo gate can be made smaller by reducing the width of the channel to provide more gain. This will have the effect of forcing all the signal charge into a smaller region. With more charge per unit area and the same capacitance per region (Cₒₓ), the output voltage will be amplified. The pulse width of Clk1 must be relatively long, so the charge packet has time to flow along the width of the CCD gate, which is a much longer distance than the gate-to-gate distance. The second transfer gate (associated with transfer clock Clk2) is used to remove the charge beneath the floating gate, allowing it to flow to the N+ diffusion region at the end of the channel. To the right of the second transfer gate is the right-most diffusion region associated with voltage Vd2 which completes the output mechanism of the double poly CCD-based structure. FIG. 8B shows a set of typical clock waveforms. These waveforms assume that the transfer gates are double poly and therefore have a built-in directionality.

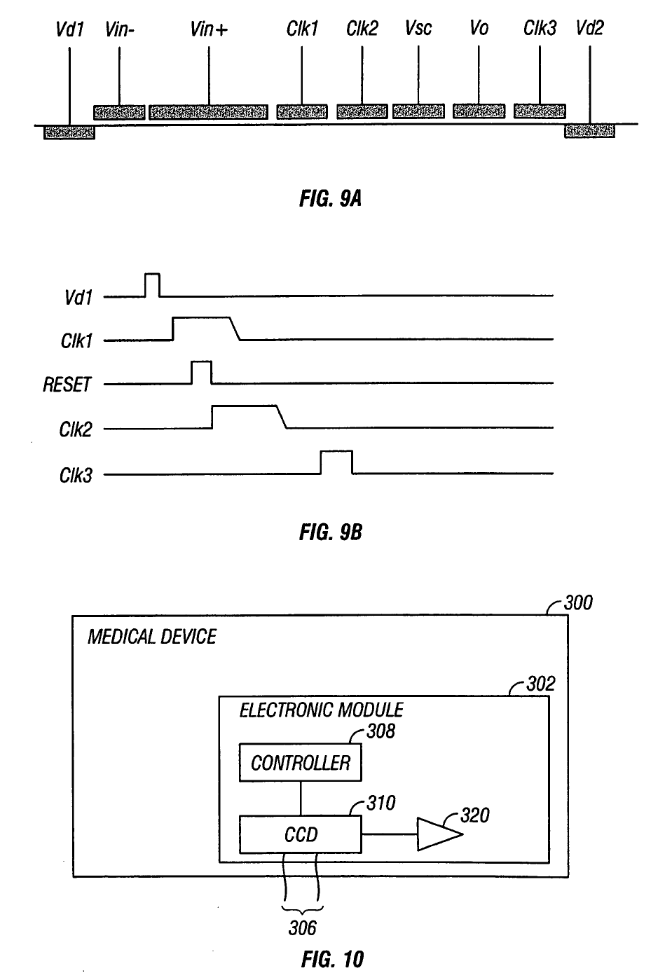

FIG. 9A shows a specific implementation of a single poly CCD-based structure, with FIG. 9B displaying a corresponding timing diagram. As described for FIG. 8A, the left-most diffusion region (associated with voltage Vd1) and first two poly gates (Vin− and Vin+) form the “fill-and-spill” input. The two gates tied to transfer clocks Clk1 and Clk2 continue the transfer of the charge packet towards the output. The gate tied to Vsc screens the poly1 Vo gate from the transfer clock Clk1, and the right-most diffusion region Vd2 and final three gates (Vsc, Vo, and Clk3) form the output mechanism from the single poly CCD-based structure.

One specific application of the current invention is for use in amplifying signals taken from electrocardiogram (ECG) electrodes in a medical monitoring and/or diagnostic device which may be implanted into a patient or an animal. The CCD-based structure can be integrated into the circuit or IC chip of the medical device. One ECG electrode is commonly used as a reference voltage, and the other ECG electrode is used as a signal voltage. Both electrodes are attached to a patient's body, and their respective ends are connected to gates in the CCD-based structure which control the input of charge into the CCD-based structure. A charge packet equal to the difference in voltages can be created and amplified by the method described above. Advantageously, a CCD-based amplifier using the present approach can be implemented in a smaller area than a comparable CMOS process.

FIG. 10 shows a medical monitoring and/or diagnostic device 300 which may be implantable inside the body of a human or animal body. The medical device 300 includes an electronic module 302 that receive signals from a plurality of electrodes 306, such as ECG electrodes. In the electronic module 302, a CCD-based structure 306 is implemented as a preamplifier 310 for an amplifier 320 which may be a CMOS device. Examples of CCD-based structures are shown in FIGS. 1-6, 8A, and 9A. A controller 308 is used to control the voltages and timing of the voltages of the CCD gates to input, store, accumulate, and move the charges among the CCD gates, as described above. The controller 308 may be a clock voltage controller. The gain obtained by the method of this invention can greatly relax noise requirements for any later amplification by transistors (e.g., the first amplifier in the ECG chain), and thus the area occupied by the transistor can also be reduced significantly. This aids in the integration of the CCD-based structure into a larger silicon device incorporating several functions, such as the monitoring and/or diagnostic functions of an implantable medical device.

The electrode connections preferably are directly inputted into the CCD. This results in a high impedance value. This is advantageously because the biological signal sources have a fairly significant impedance. Electrodes that do not load down the source can be an advantage in that maximum signal can be obtained. Commonly, one of the ECG electrodes is connected to the housing of the battery and/or housing of the medical device, so that having high impedance in both electrodes is not completely necessary. Although having high impedance in both sensing electrodes can be helpful in that it results in high flexibility of ECG electrode connections. In some specific situations, there may be no choice in physiological location of the housing (or battery) connection and yet there may be a need to sense differentially at some other location of the body. In cases like this, two high impedance electrodes would be useful or even required. Another reason high impedance electrodes are desirable is the problem of “electroplating” where dc currents in the electrode system can result which in turn cause physiological damage to tissues (i.e., a burning or reddening at the electrode sites). If the electrodes are low impedance, then some means of blocking DC currents is required, usually a blocking capacitor. Even with high impedance electrodes, it is desirable to incorporate a blocking capacitor, but it can be much smaller and it can be integrated onto the IC chip sometimes, providing a significant size/weight advantage. For use in small research animals, such as mice, even the capacitor size can be significant. Furthermore, if there is a requirement to sense all the way down to dc (i.e., 0 frequency), then no blocking capacitor is used and very high impedance electrodes simplify the interfacing.

While the description and drawings illustrate the invention as being implemented in an surface-channel CCD device, it is to be understood that the invention could also be implemented in alternative CCD configurations, such as buried-channel CCDs, bulk-channel CCDs, or MOS-type CCDs. The drawings show the device as being formed with a n-channel implementation, but the device could also be formed with a p-channel implementation as well.

It is to be understood that the above description is intended to be illustrative and not restrictive. Many embodiments will be apparent to those of skill in the art upon reviewing the above description. The scope of the invention should, therefore, be determined not with reference to the above description, but instead should be determined with reference to the appended claims alone with their full scope of equivalents.

1. A method of amplifying a signal, the method comprising:
inputting a signal to a CCD-based device which includes a first gate forming a first capacitor and a second gate forming a second capacitor, the first capacitor having a surface area larger than a surface area of the second capacitor;
converting the input signal into a charge packet having a voltage associated therewith;
transferring the charge packet from the first capacitor to the second capacitor of the CCD-based device, the voltage associated with the charge packet being multiplied by a ratio of the surface area of the first capacitor divided by the surface area of the second capacitor; and
producing an amplified output signal from the multiplied voltage.

2. The method of claim 1, wherein inputting the signal comprises connecting an end of a first electrode to a human or animal body and another end of the first electrode to the CCD-based device.

3. The method of claim 2,
wherein inputting the signal comprises supplying charges from the first electrode to a diffusion region of the CCD-based device; and
wherein converting the signal into a charge packet comprises converting the charges from the first electrode in the diffusion region to the charge packet for the first capacitor, the charge packet being proportional to a voltage associated with the first electrode.

4. The method of claim 2, wherein inputting the signal comprises connecting an end of a second electrode to a human or animal body and another end of the second electrode to the CCD-based device.

5. The method of claim 4,
wherein inputting the signal comprises connecting the end of the first electrode to the first gate and connecting the end of the second electrode to a third gate of the CCD-based device, the first electrode having a first voltage associated therewith and the second electrode having a second voltage associated therewith; and
wherein converting the signal into a charge packet comprises applying a voltage to a diffusion region of the CCD-based device to generate the charge packet for the first capacitor which is proportional to a difference between the first voltage and the second voltage.

6. The method of claim 1, further comprising sampling the signal to create a discrete sample of the input signal prior to converting the discrete sample of the input signal into a charge packet.

7. The method of claim 1, wherein the charge packet is transferred from the first capacitor to the second capacitor in a substantially noiseless manner.

8. The method of claim 1,
wherein the input signal is used to generate a plurality of charge packets in a plurality of input cycles; and
wherein the plurality of charge packets are transferred to and stored in the second capacitor to generate the multiplied voltage before producing the amplified output signal from the multiplied voltage.

9. The method of claim 1, wherein producing the amplified output signal comprises transferring the charge packet to a floating diffusion region of the CCD-based device.

10. The method of claim 1, wherein producing the amplified output signal comprises transferring the charge packet to a floating gate of the CCD-based device.

11. A method of amplifying a signal, the method comprising:
inputting a signal to a CCD-based device which includes a plurality of gates forming a plurality of capacitors;
converting the input signal into a charge packet having a voltage associated therewith;
transferring the charge packet during an input cycle to a storage capacitor associated with one of the plurality of gates;
storing multiple charge packets in the storage capacitor over a plurality of input cycles by not resetting the storage capacitor during each of the plurality of input cycles, an accumulated voltage associated with the charge packets being equal to a sum of the voltages associates with each of the multiple charge packets stored in the storage capacitor; and
producing an amplified output signal from the accumulated voltage.

12. The method of claim 11, wherein inputting the signal comprises connecting an end of at least one electrode to a human or animal body and another end of the at least one electrode to the CCD-based device.

13. The method of claim 11, further comprising sampling the signal to create a discrete sample of the input signal prior to converting the discrete sample of the input signal into a charge packet.

14. The method of claim 11, wherein the charge packets are transferred to the storage capacitor in a substantially noiseless manner.

15. The method of claim 11, wherein a programmable voltage gain is obtained from the accumulated voltage by varying the number of charge packets accumulated in the storage capacitor before resetting the storage capacitor.

16. A device comprising:
a CCD-based device including a first gate forming a first capacitor and a second gate forming a second capacitor, the first capacitor having a surface area larger than a surface area of the second capacitor; and
a controller configured to input a signal to the CCD-based device; convert the input signal into a charge packet having a voltage associated therewith; transfer the charge packet from the first capacitor to the second capacitor of the CCD-based device, the voltage associated with the charge packet being multiplied by a ratio of the surface area of the first capacitor divided by the surface area of the second capacitor; and produce an amplified output signal from the multiplied voltage.

17. The device of claim 16, further comprising a first electrode having an end adapted to be connected to a human or animal body and another end connected to the CCD-based device.

18. The device of claim 17,
wherein the first electrode supplies charges to a diffusion region of the CCD-based device; and
wherein the signal is converted to a charge packet by converting the charges from the first electrode in the diffusion region to the charge packet for the first capacitor, the charge packet being proportional to a voltage associated with the first electrode.

19. The device of claim 17, further comprising a second electrode having an end adapted to be connected to a human or animal body and another end connected to the CCD-based device.

20. The device of claim 19,
wherein the signal is inputted by connecting the end of the first electrode to the first gate and connecting the end of the second electrode to a third gate of the CCD-based device, the first electrode having a first voltage associated therewith and the second electrode having a second voltage associated therewith; and
wherein the signal is converted into the charge packet by applying a voltage to a diffusion region of the CCD-based device to generate the charge packet for the first capacitor which is proportional to a difference between the first voltage and the second voltage.

21. The device of claim 16, wherein the controller is configured to sample the signal to create a discrete sample of the input signal prior to converting the discrete sample of the input signal into a charge packet.

22. The device of claim 16, wherein the charge packet is transferred from the first capacitor to the second capacitor in a substantially noiseless manner.

23. The device of claim 16,
wherein the controller is configured to generate a plurality of charge packets in a plurality of input cycles from the input signal; and
wherein the controller is configured to transfer and store the plurality of charge packets in the second capacitor to generate the multiplied voltage before producing the amplified output signal from the multiplied voltage.

24. The device of claim 16, wherein the CCD-based device comprises a single polysilicon structure or a double polysilicon structure.

25. A device comprising:
a CCD-based device including a plurality of gates forming a plurality of capacitors; and
a controller configured to convert an input signal into a charge packet having a voltage associated therewith; transfer the charge packet during an input cycle to a storage capacitor associated with one of the plurality of gates; store multiple charge packets in the storage capacitor over a plurality of input cycles by not resetting the storage capacitor during each of the plurality of input cycles, an accumulated voltage associated with the charge packets being equal to a sum of the voltages associates with each of the multiple charge packets stored in the storage capacitor; and produce an amplified output signal from the accumulated voltage.

26. The device of claim 25, further comprising at least one electrode each having an end adapted to be connected to a human or animal body and another end connected to the CCD-based device.

27. The device of claim 25, wherein the controller is configured to sample the signal to create a discrete sample of the input signal prior to converting the discrete sample of the input signal into a charge packet.

28. The device of claim 25, wherein the charge packets are transferred to the storage capacitor in a substantially noiseless manner.

29. The device of claim 25, wherein the controller is configured to produce a programmable voltage gain from the accumulated voltage by varying the number of charge packets accumulated in the storage capacitor before resetting the storage capacitor.
